(19) United States
(12) Patent Application Publication
(10) Pub. No.: US 2010/0038151 A1
(43) Pub. Date: Feb. 18, 2010

(54) Method for automatic switching between a cursor controller and a keyboard of depressible touch panels

(76) Inventor: Stephen Chen, Shengang Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,684

(22) Filed: Aug. 14, 2008

(51) Int. Cl. G06F 3/041

(52) U.S. Cl. 178/18.03

(57) ABSTRACT

A method for automatic switching between a cursor controller and a keyboard of depressible touch panels includes at least the following procedures: 1. setting operation modes for a touch panel in a cursor controller state and a keyboard state that are switchable alternately; 2. detecting sliding (movement) of a user's finger on the touch panel in the keyboard state and switching to the cursor controller state when the detected sliding reaches a set value; 3. detecting all depressing signals in the keyboard state and entering designated characters of depressing locations and maintaining the keyboard state; 4. detecting the touch panel depressed by the user's finger in a set condition in the cursor controller state and switching to the keyboard state; 5. detecting the sliding of the user's finger in the cursor controller state and moving the cursor in a corresponding manner on a screen and maintaining the cursor controller state. By means of the procedures set forth above user's requirements can be judged automatically, and instant switching of the touch panel between the keyboard state and cursor controller state can be accomplished to enable users to perform various types of input operations and function execution.

### BACKGROUND OF THE INVENTION

1. Field of the Invention

The present invention relates to a method for automatic switching between a cursor controller and a keyboard of depressible touch panels to make automatic judgment of user's requirements during user's input operation to instantly switch a touch panel to a cursor controller state or a keyboard state to facilitate user's input operation.

2. Description of the Prior Art

The conventional computer input interface generally can be divided into a text input device and a directional device. The text input device generally includes keyboards, hand-writing input devices and the like. The directional device generally means a device to control movement of cursor on the screen, such as mouse, joystick, five-way button, touch panel, cursor control pad and the like. The five-way button and joystick mainly aim to control moving direction of the cursor, to control the moving speed is quite difficult and takes a lot of time, thus are not widely used for input operation. The mouse is more convenient for input operation, thus is most commonly used. But it requires a larger operation area to control the sliding movement of cursor. The cursor control pad has a smaller size and offers operation more convenient than the general joystick or five-way button, thus is widely adopted in a portable computer 9 (referring to FIG. 1). It generally includes a keyboard 91 and a cursor control pad 92. To facilitate operation the keyboard 91 is usually located close to a screen 93. There are designs to display a keyboard table looking like a keyboard on the screen. For instance Japan patent No. 11-345065 discloses a data entry device (referring to FIG. 2) which has two depressible keyboards 1-1 and 1-2, a matrix control portion 21, a button selector 22, a mouse selector 23, a signal change portion 24, an input dimension corrector 25 and a screen 3. Through the input dimension corrector 25 the button size can be adjusted according to user's desire to make data entry easier. Through the button and mouse selectors 22 and 23, switching between the button and mouse can be accomplished. However, to change the operation mode by switching between the button selector 22 and the mouse selector 23 is not convenient in use.

### SUMMARY OF THE INVENTION

In view of the aforesaid problems, it is an object of the present invention to provide a method for automatic switching between a cursor and a keyboard of depressible touch panels. The method includes at least the following procedures: 1. setting operation modes of a cursor controller state and a keyboard state for a touch panel; 2. detecting sliding (movement) of a user's finger on the touch panel in the keyboard state and switching to the cursor controller state when the detected sliding reaches a set value; 3. detecting all depressing signals in the keyboard state and entering designated characters according to depressed locations and maintaining the keyboard state; 4. detecting the touch panel depressed by the user's finger in a set condition in the cursor controller state and switching to the keyboard state; 5. detecting the sliding of the user's finger in the cursor controller state and moving the cursor in a corresponding manner on a screen and maintaining the cursor controller state. By means of the procedures set forth above user's requirements can be judged automatically, and instant switching of the touch panel between the keyboard state and cursor controller state can be accomplished to allow users to easily perform various types of input operations and function execution.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional technique.

FIG. 2 is a schematic view of another conventional technique (Japan patent No. 11-345065).

FIG. 3 is a block diagram of computer control interfaces according to the invention.

FIG. 4 is a perspective view of computer control interfaces according to the invention.

FIG. 5 is a schematic view of a touch panel according to the invention.

FIG. 6 is a schematic view of an embodiment of computer control interfaces according to the invention.

FIG. 7 is a procedure flowchart of the method of the invention.

FIG. 8 is a flowchart of the method of the invention.

FIG. 9 is a flowchart of a second embodiment of the invention.

FIG. 10 is a flowchart of a third embodiment of the invention.

FIG. 11 is a block diagram of another embodiment of computer control interfaces according to the invention.

FIG. 12 is a flowchart of a fourth embodiment of the invention.

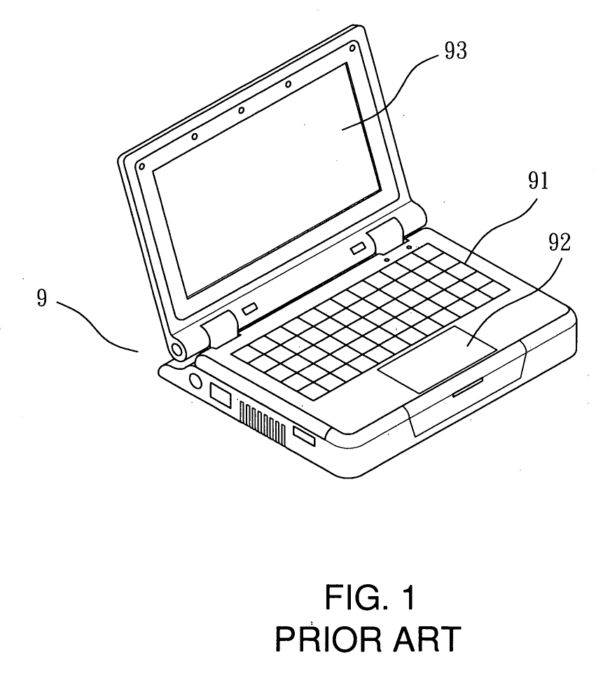

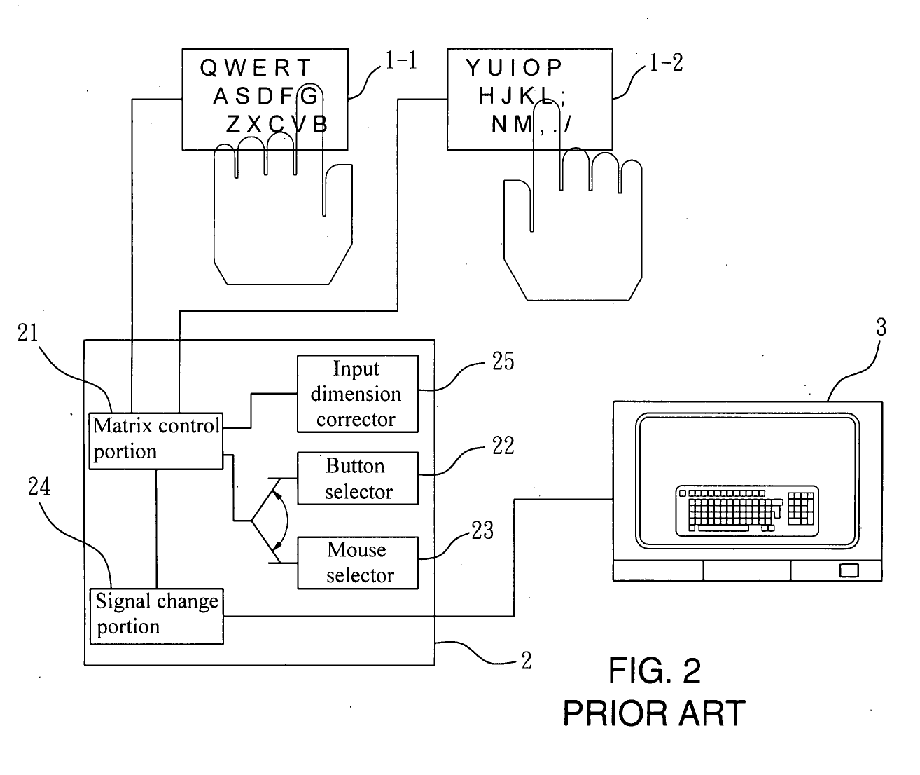

### DESCRIPTION OF THE PREFERRED EMBODIMENTS

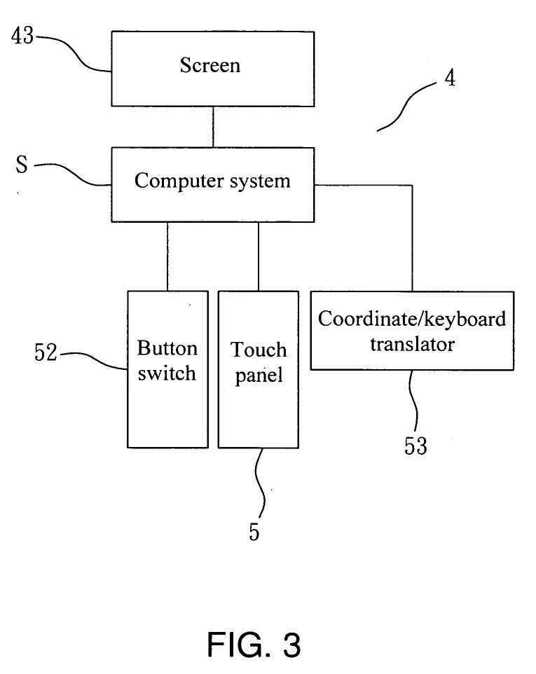

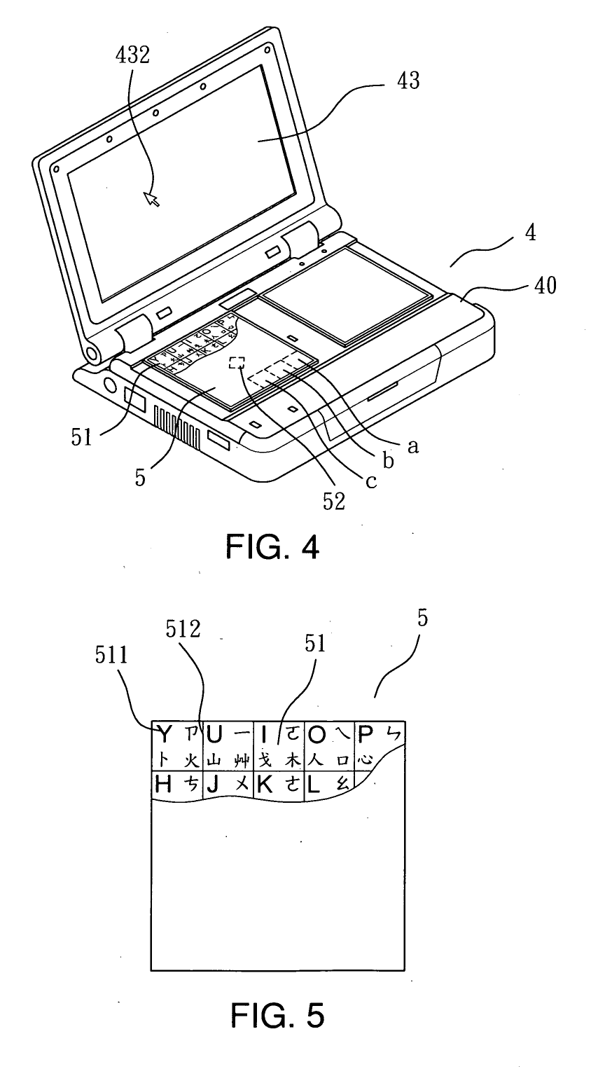

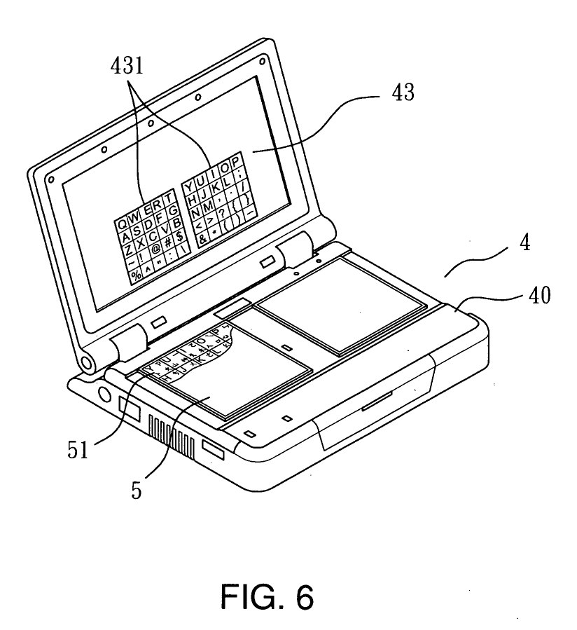

Refer to FIGS. 3, 4 and 5 for a computer control interface device 4 according to the invention. It includes a chassis 40 to hold at least one touch panel 5 movable up and down, at least one button switch 52 located beneath the touch panel 5, a screen 43 and a coordinate/keyboard translator 53. The touch panel 5 is divided into a plurality of depressible segments 51 each corresponding to a different character/command (may be character or a command) of a computer system S. When one depressible segment 51 is depressed a different signal is output (signal output of each depressible segment 51 is linked to the computer system). Each depressible segment 51 is printed with at least one character (or command) name 511 and a plurality of border lines 512 (as shown in FIG. 4). When the computer system S is started, the screen 43 displays a keyboard table 431 (referring to FIG. 6) mapping each depressible segment 51 to allow users to see and perform input operation easier without the need of lowering the head to look at depressing locations.

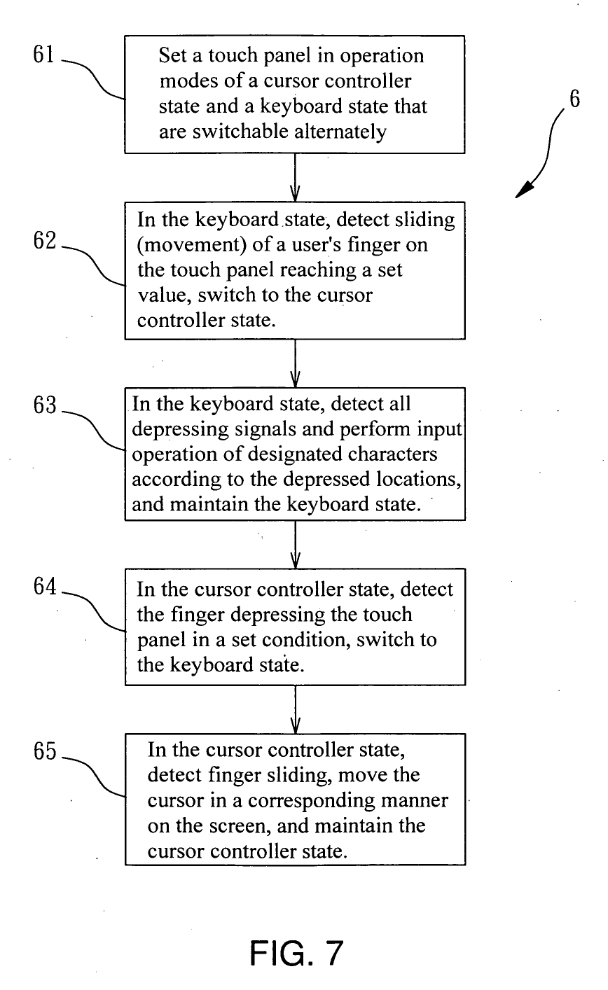

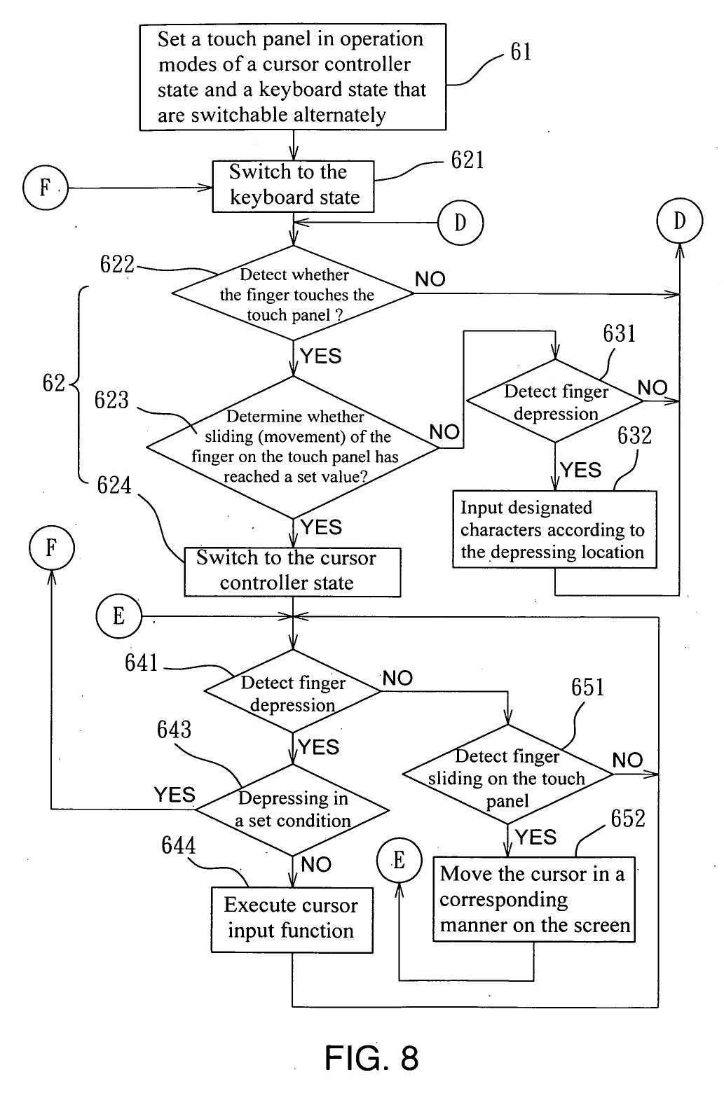

When in use for input operation, the invention provides an automatic switching method 6 between a cursor controller and a keyboard of the depressible touch panel. The method includes the following procedures (also referring to FIGS. 7 and 8):

1. Set the control panel in operation modes of a cursor controller state and a keyboard state that are switchable alternately (step 61): through the computer system S the touch panel 5 can be set in the cursor controller state to control movement of a cursor 432 on the screen 43 and input by ticking. The touch panel may also be set in the keyboard state for direct entry of characters, numerals or functions;

2. In the keyboard state, detect sliding (movement) of a user's finger on the touch panel reaching a set value, switch to the cursor controller state (step 62): when an user starts operation, switching to the keyboard state may be chosen (step 621, or switching to the cursor controller state may be chosen as shown in step 624) as an initial operation mode. When the user's finger touches the touch panel 5, the touch panel 5 detects a finger touch signal and calculates the touch coordinates (step 622) and detects whether the sliding (movement) distance of the finger has reached the set value (the set value is made by the user according to requirements). If the sliding (movement) distance has reached the set value, the touch panel 5 is switched to the cursor controller state (steps 623 and 624);

3. In the keyboard state, detect all depressing signals and perform input operation of designated characters according to depressed locations (step 63): The touch panel 5 detects a finger depressing signal, such as on one depression segment 51 at location 511 where character “Y” is indicated as shown in FIG. 5, then the designated character “Y” of the depressed location is entered (steps 631 and 632);

4. In the cursor controller state, detect the finger depressing the touch panel in a set condition, switch to the keyboard state (step 64): when finger depressing the touch panel 5 in the set condition is detected (steps 641 and 643), switch to the keyboard state (step 621);

5. In the cursor controller state, detect sliding of the finger, move the cursor in a corresponding manner on the screen, and the cursor controller state is maintained (step 65): When the touch panel 5 is in the cursor controller state, and finger sliding is detected (step 651), move the cursor 432 on the screen 43 corresponding to the sliding (step 652).

At step 652, in the cursor controller state, if sliding of the finger on the touch panel 5 is detected, detecting finger depression is performed immediately. If the touch panel 5 is depressed not in the set condition (steps 641, 642 and 643), execute cursor input function (step 644) and maintain the cursor controller state.

When the invention is switched to the cursor controller state (step 624, referring to FIG. 8), namely the touch panel 5 is in the cursor controller state, when finger depression is detected (step 641), and the finger depressing location is in a set condition (step 643) in which at least one of the depression segments 51 of the touch panel 5 is designated as a first preset depression zone a (referring to FIG. 4); when the finger depressing location is detected at the first preset depression zone a, step 621 is executed, and the operation mode of the touch panel 5 is switched to the keyboard state to facilitate change of the operation mode for users.

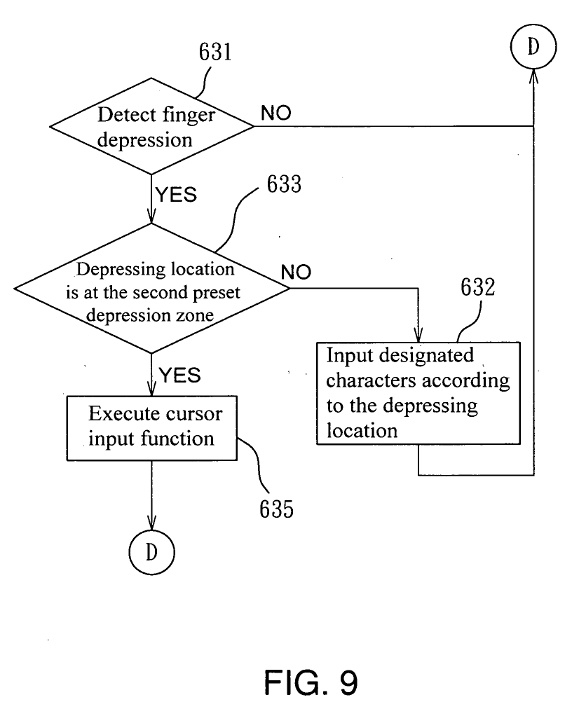

Refer to FIG. 9 for a second embodiment of the invention. In the keyboard state, in order to enable users to quickly execute cursor input function under the cursor controller state, the invention provides a second preset depression zone b in the depression segment 51 when the touch panel 5 is in the keyboard state (referring to FIG. 4), namely additional steps 633 and 635 are added after step 631. When the finger depressing location is detected at the second preset depression zone b (steps 631 and 633), cursor input function can be executed quickly (step 635) even in the keyboard state.

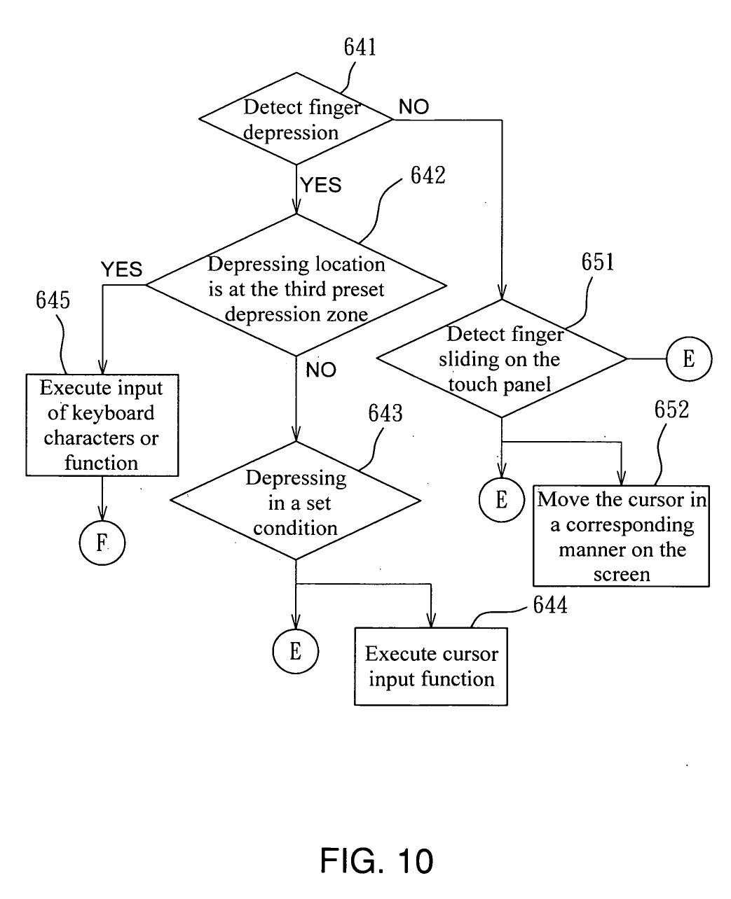

Refer to FIG. 10 for a third embodiment of the invention. In the cursor controller state, in order to enable users to quickly execute input of characters or function under the keyboard state, the invention provides a third preset depression zone c in the depression segment 51 when the touch panel 5 is in the cursor controller state (referring to FIG. 4), namely additional steps 642 and 645 are added after step 641. When the finger depressing location is detected at the third preset depression zone c (steps 641 and 642), keyboard character or function input can be executed quickly (step 645) even in the cursor controller state.

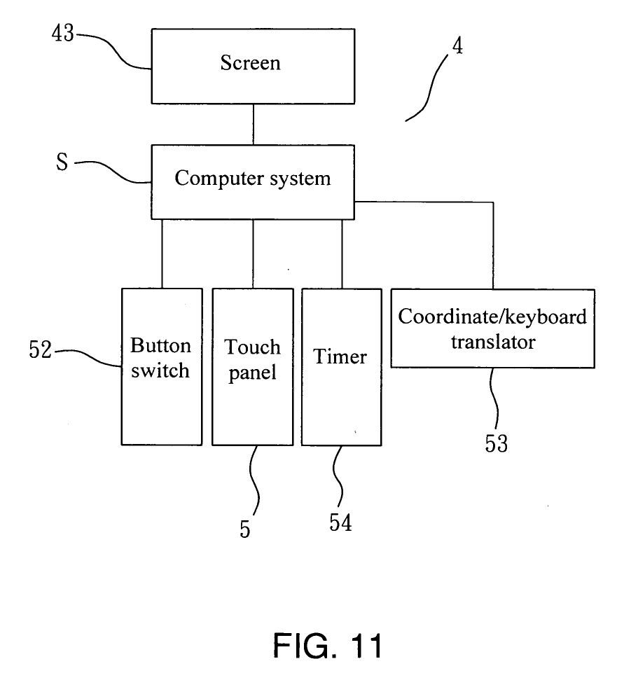

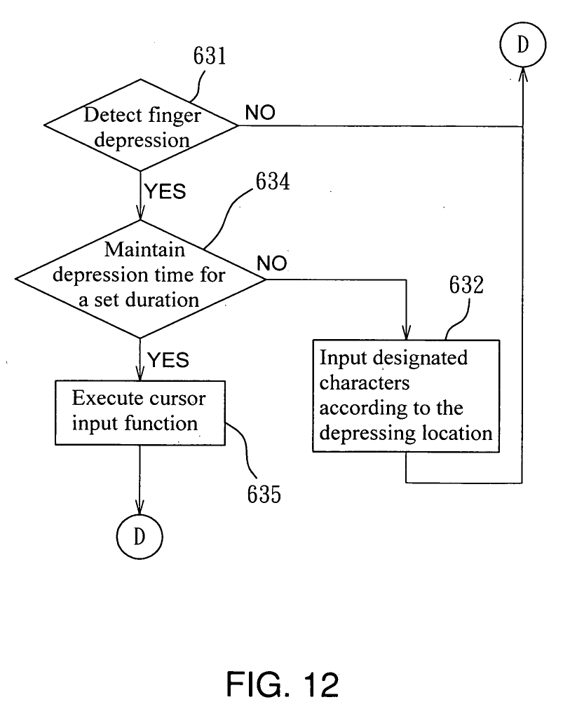

Refer to FIG. 11 for a fourth embodiment of the invention. Based of the embodiments set forth above, the computer control interface device 4 may further include a timer 54. In the cursor controller state, when finger depression is detected (step 641, also referring to FIG. 8) under a set condition (step 643) in which the touch panel 5 is depressed for a selected duration (set by the timer 54 according to user's requirement), then switch to the keyboard state (step 621). In the keyboard state (referring to FIG. 12), steps 634 and 634 are added after step 631, in which finger depression on the touch panel 5 is detected to maintain a set time period (step 634) counted by the timer 54 (the time period also is set according to user's requirements), then cursor input function is executed (step 635). Thereby in the keyboard state users can directly depress the touch panel for a set time period to immediately execute the cursor input function.

As a conclusion, the invention provides fast and convenient operation for users, and can automatically judge users' requirements to immediately switch operation modes of the panel to allow the users to execute various types of input operations and functions.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A method for automatic switching between a cursor controller and a keyboard of depressible touch panels, comprising at least the steps of:
setting operation modes of a touch panel in a cursor controller state and a keyboard state that are switchable alternately;
detecting sliding (movement) of a user's finger on the touch panel in the keyboard state and switching to the cursor controller state when the sliding reaches a set value;
detecting all depressible signals in the keyboard state and entering designated characters according to depressed locations and maintaining the keyboard state;
detecting finger depression on the touch panel in a set condition in the cursor controller state and switching to the keyboard state; and
detecting sliding of the finger in the cursor controller state and moving a cursor in a corresponding manner on the screen and maintaining the cursor controller state.

2. The method of claim 1, wherein the detecting sliding of the finger in the cursor controller state also detects the finger depression on the touch panel not in the set condition, then cursor input function is executed and the cursor controller state is maintained.

3. The method of claim 1, wherein the set condition at the step of finger depression on the touch panel in a set condition in the cursor controller state sets at least one first preset depression zone on a depression segment of the touch panel, the operation mode of the touch panel being switched to the keyboard state when the first preset depression zone is depressed.

4. The method of claim 1 further including detection of the finger depression on at least one second preset depression zone on a depression segment of the touch panel in the keyboard state and executing cursor input function.

5. The method of claim 1 further including detection of the finger depression on at least one third preset depression zone on a depression segment of the touch panel in the cursor controller state and executing input of keyboard characters or function.

6. The method of claim 1, wherein the set condition at the step of detecting finger depression on the touch panel in a set condition in the cursor controller state is a time period for maintaining the finger depression on the touch panel and switches to the keyboard state when the time period is reached.

7. The method of claim 1 further including detecting the finger depression on the touch panel for a set time period in the keyboard state and executing a cursor input operation.
